(19) United States
(12) Patent Application Publication
(10) Pub. No.: US 2014/0088931 A1
(43) Pub. Date: Mar. 27, 2014

(54) COMPUTER PRODUCT, VERIFICATION SUPPORT METHOD, AND VERIFICATION SUPPORT APPARATUS

(71) Applicant: Fujitsu Limited, Kawasaki-shi (JP)

(72) Inventors: Hidekatsu SASAKI, Kawasaki (JP); Tsukasa TENMA, Kawasaki (JP); Hirooki HAYASHI, Kawasaki (JP)

(73) Assignee: Fujitsu Limited, Kawasaki-shi (JP)

(21) Appl. No.: 14/031,072

(22) Filed: Sep. 19, 2013

(30) Foreign Application Priority Data
Sep. 21, 2012 (JP) 2012-208983

(51) Int. Cl. G06F 17/50

(52) U.S. Cl. CPC G06F 17/50
USPC 703/1

(57) ABSTRACT

A computer-readable recording medium stores a verification support program that causes a computer to execute a process that includes generating based on design information expressing an object, component information indicating components of the object, the components indicated correspond to a shape to which a design rule concerning positional relation applies and for at least one of the components, a number of vertices of the component is reduced; calculating based on the generated component information, information indicating a positional relation between the components; determining whether the calculated information indicating the positional relation meets a condition prescribed by the design rule; and outputting a determination result.

### CROSS REFERENCE TO RELATED APPLICATIONS

This application is based upon and claims the benefit of priority of the prior Japanese Patent Application No. 2012-208983, filed on Sep. 21, 2012, the entire contents of which are incorporated herein by reference.

### FIELD

The present invention relates to a computer product, a verification support method, and a verification support apparatus.

### BACKGROUND

According to a conventional technique, computer aided design (CAD) is used for designing an object. For example, according to a known technique, a portion matching an input shape is identified based on CAD data (see, for example, Japanese Laid-Open Patent Publication No. 2010-211434).

According to a further technique, in checking the clearance between components, the degree of leeway is displayed on each part of the components according to the amount of clearance between the components (see, for example, Japanese Laid-Open Patent Publication No. 2007-48004). Another technique is also known, according to which components similar in size and material to each other are retrieved from a database and are displayed using CAD (see, for example, Japanese Laid-Open Patent Publication No. 2005-49923).

Nonetheless, according to the conventional techniques, when a portion of a designed object that needs to be verified according to a design rule related the positional relation between components is identified, if the shapes of the components are complicated, calculation of the positional relation between the components is difficult.

### SUMMARY

According to an aspect of an embodiment, a computer-readable recording medium stores a verification support program that causes a computer to execute a process. The process includes generating based on design information expressing an object, component information indicating components of the object, the components indicated correspond to a shape to which a design rule concerning positional relation applies and for at least one of the components, a number of vertices of the component is reduced; calculating based on the generated component information, information indicating a positional relation between the components; determining whether the calculated information indicating the positional relation meets a condition prescribed by the design rule; and outputting a determination result.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is an explanatory diagram of an example of operation of a verification support apparatus;

FIG. 2 is a block diagram of a hardware configuration of the verification support apparatus according to an embodiment;

FIG. 3 is an explanatory diagram of an example of design information;

FIG. 4 is an explanatory diagram of an example of a design rule;

FIG. 5 is an explanatory diagram of an example of overlapping shapes and a display dimension;

FIG. 6 is an explanatory diagram of an example of a DRC determination condition correspondence table;

FIG. 7 is an explanatory diagram of an example of a conditional expression table;

FIG. 8 is an explanatory diagram of an example of a shape pattern table;

FIG. 9 is an explanatory diagram of an example of a transformation condition correspondence table;

FIG. 10 is a block diagram of a functional configuration of the verification support apparatus;

FIG. 11 is an explanatory diagram of an example of components;

FIG. 12 is an explanatory diagram of an example of transformation for each combination;

FIG. 13 is an explanatory diagram of an example of calculation of condition determination parameters;

FIG. 14 is an explanatory diagram of an example of highlighted display;

FIG. 15 is an explanatory diagram of an example of overlapping display; and

FIGS. 16, 17, and 18 are flowcharts of an example of a verification support procedure by the verification support apparatus.

### DESCRIPTION OF EMBODIMENTS

Preferred embodiments of a verification support program, a verification support method, and a verification support apparatus will be described in detail with reference to the accompanying drawings.

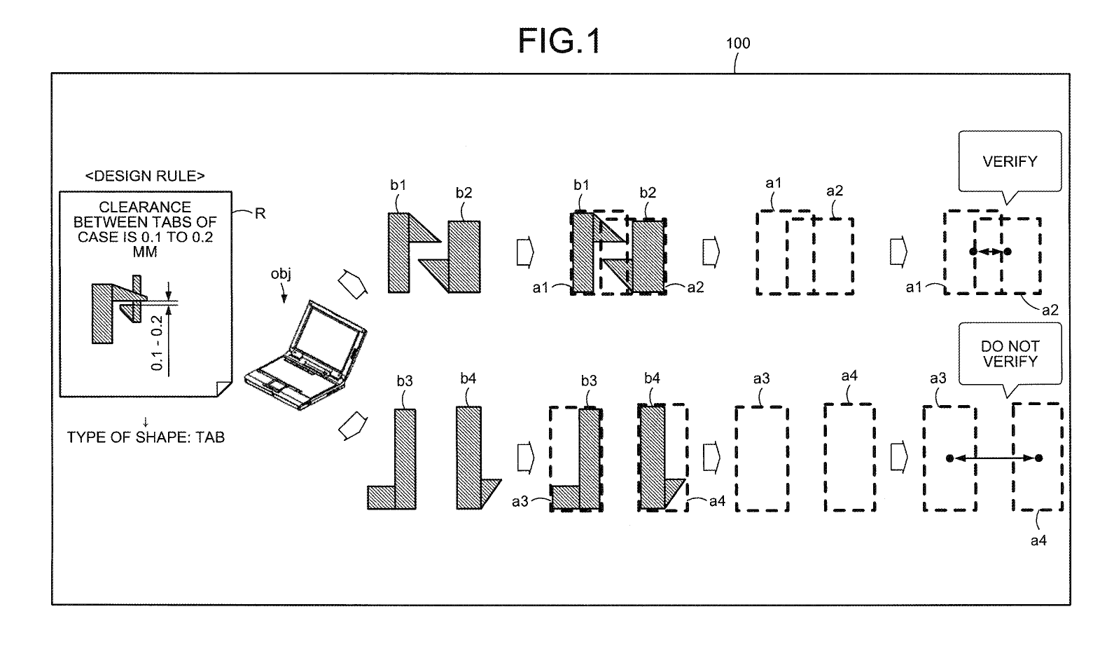

FIG. 1 is an explanatory diagram of an example of operation of the verification support apparatus. A verification support apparatus 100 is a computer that from a designed object obj, narrows down portions that need to be verified according to a design rule R related the positional relation between components. The object obj, for example, may be a personal computer (PC), as depicted in FIG. 1, or may be a machinery product, such as a server, mobile information terminal, car, and household appliance, or an architectural structure such as a building, or may be a circuit pattern for a semiconductor integrated circuit. In FIG. 1, “clearance between tabs of a case is 0.1 to 0.2 [mm]” is given as an example of the design rule R.

The verification support apparatus 100 generates based on design information expressing the object obj, component information indicating multiple components of the object obj. The components indicated correspond to shapes to which the design rule R concerning positional relations applies and for at least one of the components, the number of vertices thereof is reduced. The design information is, for example, data that indicates the shape and vertex coordinates of the object obj and that indicates the components that make up the object obj. The component information is, for example, data that identifies the vertex coordinates of a component and faces, etc. making up the component. The component information also includes data that can identify specified shapes such as a board, tab, etc. In the description hereinafter, the verification support apparatus 100 retrieves from the design information expressing the object obj, specific shapes such as a board, tab, etc. Based on vertex information and information of a face, shape, etc., described in the design information, the object obj is drawn on a computer using a CAD tool.

For example, in an upper portion of FIG. 1, design information is generated as information representing components a1 and a2, each of which is the smallest cuboid among cuboids surrounding each of components b1 and b2. For example, in a lower portion of FIG. 1, design information is generated as information representing components a3 and a4, each of which is the smallest cuboid among cuboids surrounding each of components b3 and b4. For example, if a component has many vertices despite being of a circular shape, the component may be transformed into a spherical shape, or the shape into which the component is to be transformed may be predetermined according to the shape of the component.

The verification support apparatus 100 calculates information indicating the positional relation between components, based on the generated component information. Information indicating the positional relation between components is information of, for example, the distance between barycenters, the distance between vertices, the degree of overlap of peripheral edges, etc. While the distance between barycenters is depicted in the example of FIG. 1, this is not the only case. The contents of information, such as the distance between barycenters and a degree of overlapping of peripheral edges, are determined based on each design rule R.

The verification support apparatus 100 determines whether the calculated information indicating the positional relation meets a condition prescribed by the design rule R. The condition may be a condition imposing a criterion more lax than a criterion imposed by the design rule R, or may be a condition as strict as the design rule R. The condition is determined in advance by a user, and is stored in a memory device, such as read only memory (ROM), a magnetic disk, an optical disk, and nonvolatile memory, to which the verification support apparatus 100 can access in advance.

For example, when the calculated information indicating the positional relation meets the condition, the verification support apparatus 100 determines a combination of the components b1 and b2 to be a portion that requires verification according to the design rule R, as indicated in the upper portion of FIG. 1. When the calculated information indicating the positional relation does not meet the condition, the verification support apparatus 100 determines a combination of the components b3 and b4 to be a portion that does not require verification according to the design rule R, as indicated on the lower side of FIG. 1.

The verification support apparatus 100 outputs a determination result. The verification support apparatus 100 outputs the determination result in the form of display on a display to which the verification support apparatus 100 can access or storage to a memory device, such as RAM, a magnetic disk, and an optical disk, that the verification support apparatus 100 can access. When the determination result is displayed on the display in the case of the condition being met, multiple components may be displayed in a highlighted form, or prepared shapes may be displayed in an overlapping form, or components of the same size may be displayed in an overlapping form.

For example, even if components are tabs, the components may have differing numbers of vertices depending on the type of the component. A component having many vertices may be of a complicated shape. For example, if the positional relation between components is to be verified based on the distance between the barycenter of one component and the barycenter of another component, or based on the distance between nearest vertices of two components, if the number of vertices is great, the calculation may become complicated and/or the volume of calculations may become great. According to the verification support apparatus 100 of FIG. 1, the number of vertices is reduced. A reduction in the number of vertices simplifies the calculation of the positional relation between components. As a result, portions requiring verification according to the design rule R can be narrowed down for the object obj.

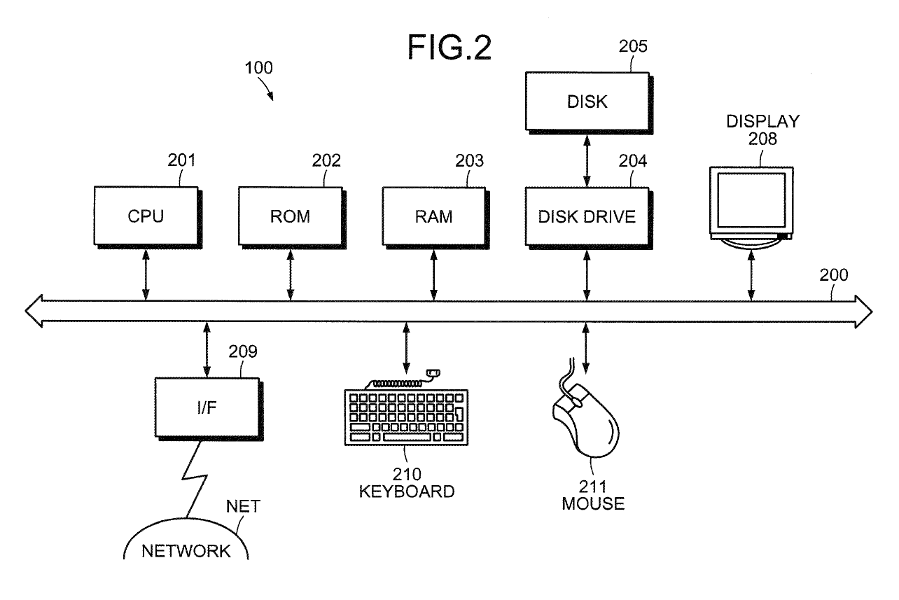

FIG. 2 is a block diagram of a hardware configuration of the verification support apparatus 100 according to the embodiment. As depicted in FIG. 2, the verification support apparatus 100 includes a central processing unit (CPU) 201, read-only memory (ROM) 202, random access memory (RAM) 203, a disk drive 204, a disk 205, a display 208, an interface (I/F) 209, a keyboard 210, and a mouse 211, respectively connected by a bus 200.

The CPU 201 governs overall control of the verification support apparatus 100. The ROM 202 stores therein programs such as a boot program. The RAM 203 is used as a work area of the CPU 201. The disk drive 204, under the control of the CPU 201, controls the reading and writing of data with respect to the disk 205. The disk 205 stores therein data written under control of the disk drive 204, the data being read by a computer. A magnetic disk or an optical disk may be employed as the disk 205.

The display 208 displays, for example, data such as text, images, functional information, etc., in addition to a cursor, icons, and/or tool boxes. A cathode ray tube (CRT), a thin-film-transistor (TFT) liquid crystal display, a plasma display, etc., may be employed as the display 208.

The I/F 209 is connected to a network NET such as a local area network (LAN), a wide area network (WAN), and the Internet through a communication line and is connected to other apparatuses through the network NET. The I/F 209 administers an internal interface with the network NET and controls the input/output of data from/to external apparatuses. For example, a modem or a LAN adaptor may be employed as the I/F 209.

The keyboard 210 includes, for example, keys for inputting letters, numerals, and various instructions and performs the input of data. Alternatively, a touch-panel-type input pad or numeric keypad, etc. may be adopted. The mouse 211 is used to move the cursor, select a region, or move and change the size of windows. A track ball or a joy stick may be adopted provided each respectively has a function similar to a pointing device.

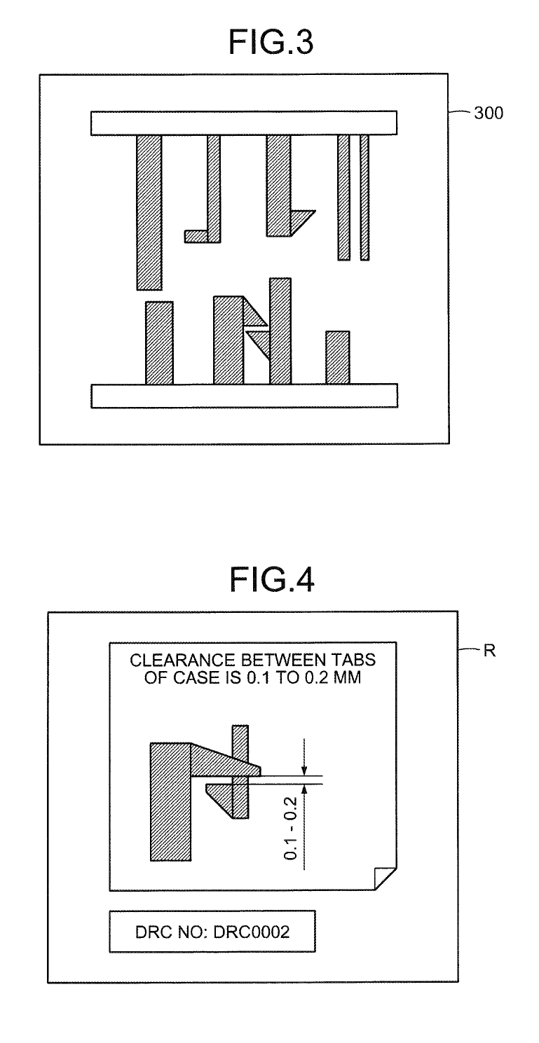

FIG. 3 is an explanatory diagram of an example of design information. Design information 300 is, for example, CAD data having information of the positions of vertices representing the shapes of components making up the object obj. As describe above, the object obj may be a machinery product, such as a PC, server, mobile information terminal, car, and household appliance, or an architectural structure such as a building, or may be a circuit pattern of a semiconductor integrated circuit. In this example, the design information 300 may be three-dimensional information or two-dimensional information.

When the design information 300 is three-dimensional information, a three-dimensional rectangular coordinates system composed of the X-axis, Y-axis, and Z-axis is defined in the design information 300. For example, the design information 300 is stored in a memory device, such as the disk 205. Component information is shape information making up part of the design information 300, and is made up of the coordinates of vertices from the origin of the rectangular coordinates system defined in the design information 300 and of face information. The face information indicates, for example, in what order the vertices are connected to each other.

FIG. 4 is an explanatory diagram of an example of a design rule. For example, the design rule R is stored as a combination of a design rule check (DRC) number (no.) and a detailed rule. In the example of FIG. 4, the DRC no. is “DRC0002” and the detailed rule defines that “clearance between tabs of a case is 0.1 to 0.2 [mm]”.

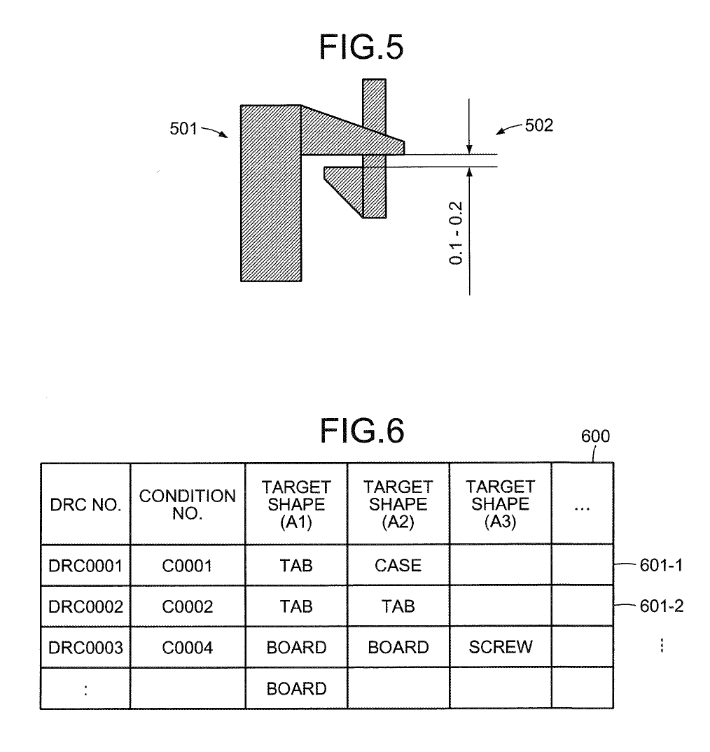

FIG. 5 is an explanatory diagram of an example of overlapping shapes and a display dimension. In the embodiment, to display a shape related to the design rule R and a dimension related to the design rule R related to an identified portion that requires verification, an overlapping shape 501 and a display dimension 502 are stored in the memory device, such as the disk 205.

FIG. 6 is an explanatory diagram of an example of a DRC determination condition correspondence table. A DRC determination condition correspondence table 600 has fields of DRC no., condition no., and target shape. DRC no. represents a number for identifying a design rule R. Condition no. represents a number for identifying a condition. Target shape represents the name of a shape to which the design rule R applies. Multiple fields of target shape are set for each design rule R. Information is entered into each field to create a record (e.g., 601-1) to be stored. The DRC determination condition correspondence table 600 is implemented by, for example, the disk 205, etc.

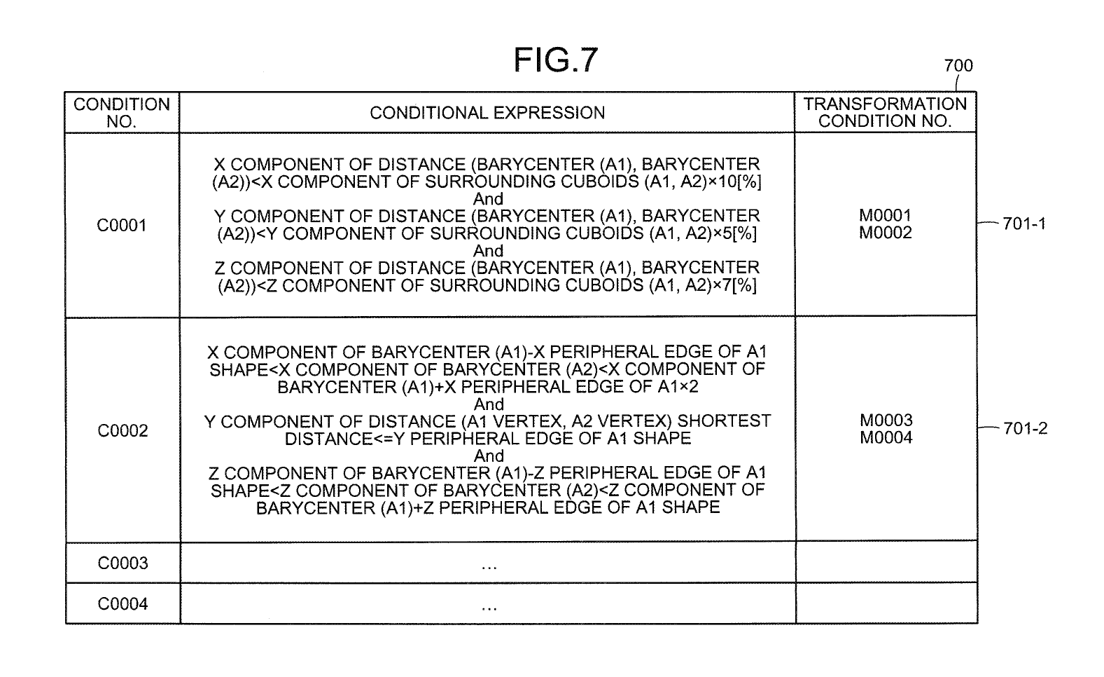

FIG. 7 is an explanatory diagram of an example of a conditional expression table. A conditional expression table 700 indicates conditional expressions. The conditional expression table 700 has fields of condition no., conditional expression, and transformation condition no. Condition no. represents a number for identifying each condition. For example, a record in the condition equation table 700 is correlated with a record in the DRC determination condition correspondence table 600 by a Condition no. Conditional equation represents a condition for determining whether the design rule R is met. Transformation condition no. represents a number for identifying a condition indicating which transformation is to be performed on the shape of a component.

Information is entered into each field to create a record (e.g., 701-1 and 701-2) to be stored. The conditional expression table 700 is implemented by the disk 205, etc.

A detailed example of the record 701-1 will be described. The record 701-1 has a condition no. “C0001” by which the record 701-1 is correlated with the record 601-1 in the DRC determination condition correspondence table 600. The conditional expression of the record 701-1 is, therefore, set based on the design rule R related to the positional relation between a tab and the case. The conditional expression is the logical product of three conditions. The first condition is “X component of distance between barycenter A1 and barycenter A2<(X component of surrounding cuboid surrounding each component)×10[%]”. The surrounding cuboid means the smallest cuboid among cuboids surrounding a component. The second condition is “Y component of distance between barycenter A1 and barycenter A2<(Y component of surrounding cuboid)×5[%]”. The third condition is “Z component of distance between barycenter A1 and barycenter A2<(Z component of surrounding cuboid)×7[%]”.

A detailed example of the record 701-2 will be described. The record 701-2 has a condition no. “C0002” by which the record 701-2 is correlated with the record 601-2 in the DRC determination condition correspondence table 600. The conditional expression of the record 701-2 is, therefore, set based on the design rule R related to a clearance between a tab and a tab. The conditional expression is the logical product of three conditions. The first condition is “X component of barycenter (A1)−X peripheral edge of A1 shape<X component of barycenter (A2)<X component of barycenter (A1)+(X peripheral edge of A1)×2”. The second condition is “shortest distance among Y components of distances between vertices between A1 and A2<=Y peripheral edge of A1 shape”. The third condition is “Z component of barycenter (A1)−Z peripheral edge of A1 shape<Z component of barycenter (A2)<Z component of barycenter (A1)+Z peripheral edge of A1 shape”. Terms of peripheral edge are included in the conditional expression concerning the clearance between tabs to confirm the degree of overlap of the tabs.

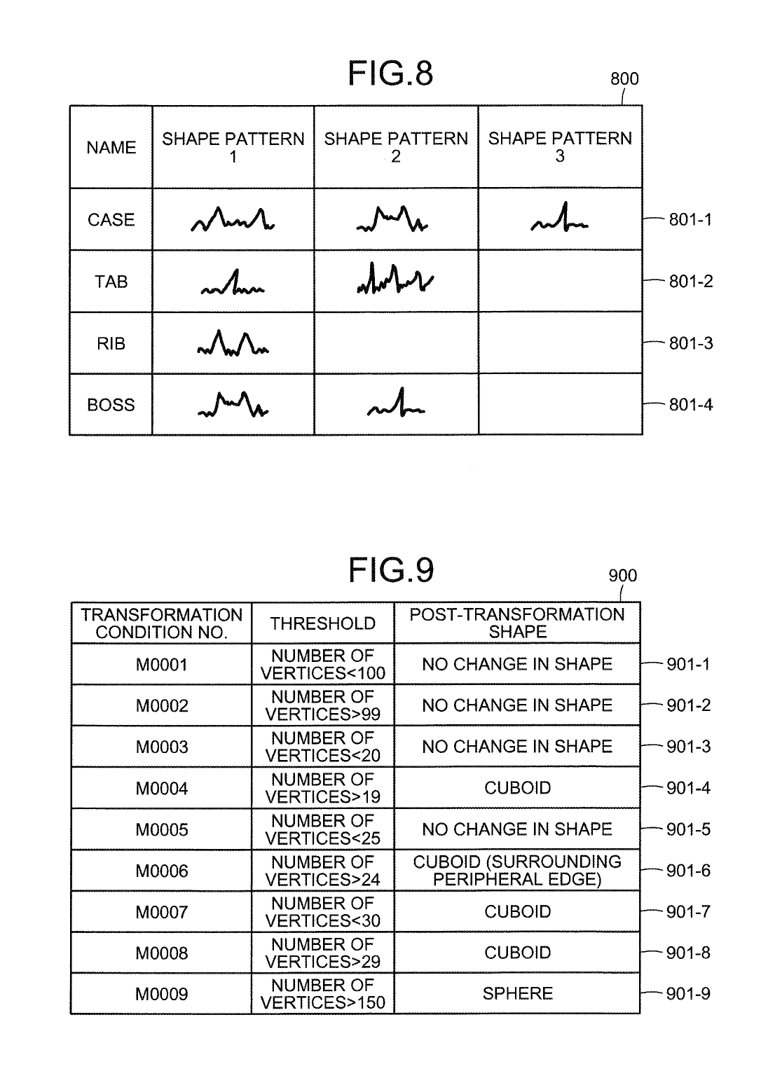

FIG. 8 is an explanatory diagram of an example of a shape pattern table. A shape pattern table 800 has fields of name and shape pattern. Name represents the name of a shape to which the design rule R applies. Shape pattern represents the pattern of the shape indicated by the name. Information is entered into each field to create a record (e.g., 801-1 to 801-4) to be stored. The shape pattern table 800 is implemented by the disk 205, etc.

FIG. 9 is an explanatory diagram of an example of a transformation condition correspondence table. A transformation condition correspondence table 900 has fields of transformation condition no., threshold, and post-transformation shape. Information is entered into each field to create a record (e.g., 901-1 to 901-9) to be stored. The transformation condition correspondence table 900 is implemented by the disk 205, etc.

Transformation condition no. represents identification information identifying a condition for determining into which shape a component is to be transformed or whether transformation is not performed. If a component meets a condition entered in the threshold field, component information is generated so that the component is transformed into the shape indicated in the post-transformation shape field. Each post-transformation shape is determined according to the shape of each component. For example, the transformation condition correspondence table 900 is correlated with the conditional expression table 700 by a transformation condition no. Thus, the shape to which the design rule R applies is correlated with a post-transformation shape.

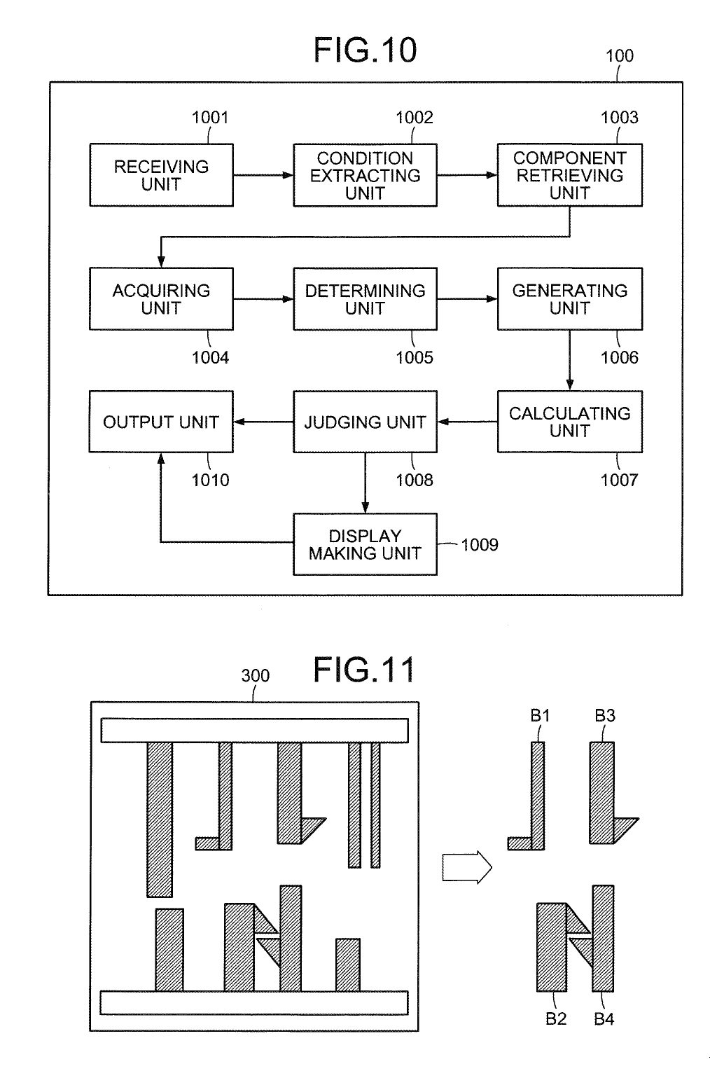

FIG. 10 is a block diagram of a functional configuration of the verification support apparatus. The verification support apparatus 100 includes a receiving unit 1001, a condition extracting unit 1002, a component retrieving unit 1003, an acquiring unit 1004, a determining unit 1005, a generating unit 1006, a calculating unit 1007, a judging unit 1008, a display making unit 1009, and an output unit 1010.

The receiving unit 1001 receives input of the design information 300 and the DRC no. of the design rule R. For example, a user who performs verification inputs, via an input device, the design information 300 and the DRC no. of the design rule R to the verification support apparatus 100. The mouse 211, keyboard 210, etc., are used as the input unit. For example, a case is assumed where “DRC0002” is input as the DRC no. In this case, the overlapping shape 501 and the display dimension 502 have been preliminarily correlated in the design rule R.

The condition extracting unit 1002 extracts a target shape from the DRC determination condition correspondence table 600, based on the DRC no. received by the receiving unit 1001. For example, the condition extracting unit 1002 extracts the condition no. “C0002”, the target shape A1 “tab”, and the target shape A2 “tab” which correspond to the DRC no. “DRC0002”.

The condition extracting unit 1002 extracts from the conditional expression table 700, a conditional expression and a transformation condition no. which correspond to the condition no. For example, the condition extracting unit 1002 extracts from the conditional expression table 700, the conditional expression and the transformation conditions no. “M0003” and “M0004” which correspond to the condition no. “C0002”.

The condition extracting unit 1002 extracts from the shape pattern table 800, a shape pattern that has a name identical to the name of the extracted target shape. For example, the condition extracting unit 1002 extracts from the shape pattern table 800, the shape patterns 1 and 2 of which the name is “tab”.

The component retrieving unit 1003 retrieves from the design information 300 received by the receiving unit 1001, component information expressing the component whose shape matches the shape of the shape pattern extracted by the condition extracting unit 1002.

FIG. 11 is an explanatory diagram of an example of components. For example, using a conventional technique (e.g., Japanese Laid-Open Patent Application No. 2011-150667), the component retrieving unit 1003 retrieves from the design information 300, component information expressing a component whose shape matches a shape to which the design rule applies, based on the shape patterns 1 and 2 extracted by the condition extracting unit 1002. As depicted in FIG. 11, components B1 to B4 are retrieved in this example. The result of the retrieval may be stored to, for example, a memory device, such as the disk 205.

The acquiring unit 1004 acquires from the design information 300, component information for multiple components corresponding to the shape to which the design rule R related to the positional relation applies. In this example, the acquiring unit 1004 acquires from among the component information retrieved by the component retrieving unit 1003, component information for two or more components.

The generating unit 1006 generates based on the design information 300 expressing the object obj, component information that indicates the components of the object obj. The components indicated correspond to a shape to which the design rule R applies and for at least one of the components, the number of vertices thereof is reduced. For example, based on acquired design information, the generating unit 1006 generates component information indicating multiple components, among which the number of vertices of at least one component is reduced.

The determining unit 1005 determines whether to reduce the number of vertices of a component, based on a comparison between the number of vertices indicated by component information and a threshold corresponding to a shape to which the design rule R applies. The generating unit 1006 generates component information indicating the components for which the number of vertices has been determined for reduction by the determining unit 1005.

Based on a comparison between the number of vertices of the component indicated by component information and a threshold corresponding to the shape to which the design rule R applies, the determining unit 1005 may determine from among shapes having fewer vertices, the shape into which the component is to be transformed. The generating unit 1006 generates component information indicating the components that have been transformed into the shape determined by the determining unit 1005.

For example, based on the transformation condition Nos. “M0003” and “M0004” received by the condition extracting unit 1002, the determining unit 1005 acquires thresholds and post-transformation shapes corresponding to the transformation condition nos. in the transformation condition correspondence table 900. The acquired thresholds and post-transformation shapes are “number of vertices<20, no change in shape” and “number of vertices>19, cuboid”. For example, when the number of vertices is less than 20, the determining unit 1005 determines that no shape transformation is performed. When the number of vertices is greater than or equal to 20, the determining unit 1005 determines that a component is transformed into the smallest cuboid among cuboids surrounding the component. A detailed example will be described based on an assumption that it is determined that the shapes of the components B1 to B4 are to be transformed.

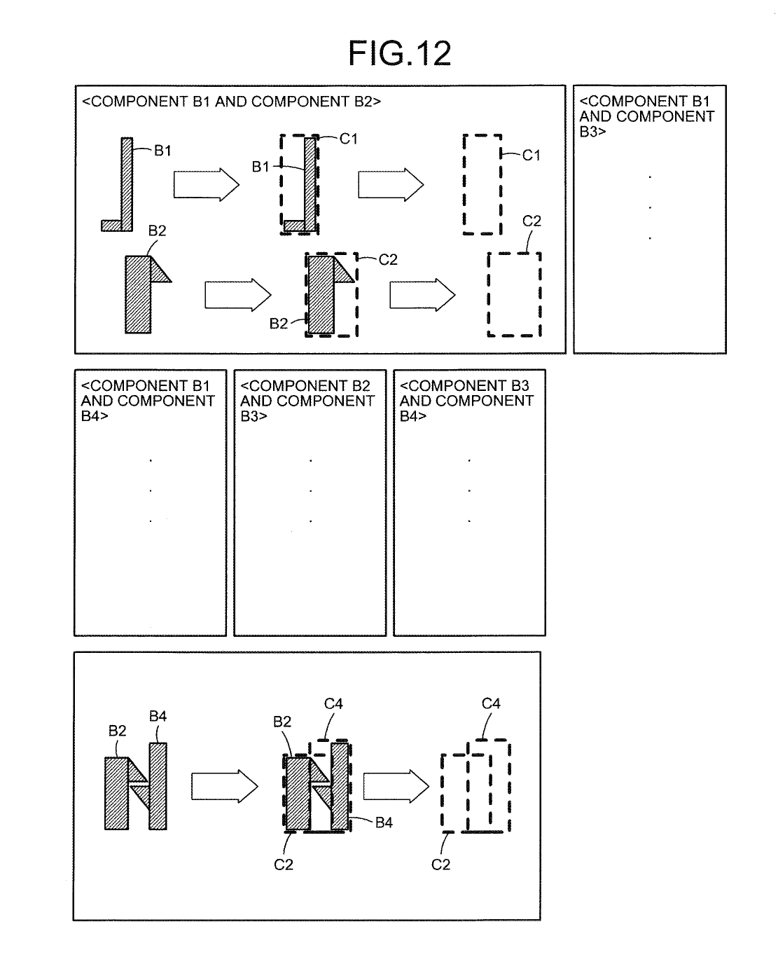

FIG. 12 is an explanatory diagram of an example of transformation for each combination. For example, the generating unit 1006 transforms into a cuboid, a component for which transformation has been determined by the determining unit 1005. In the example of FIG. 12, the component B1 is transformed into a cuboid, which is a component C1, the component B2 is transformed into a cuboid, which is a component C2, and the component B4 is transformed into a cuboid, which is a component C4.

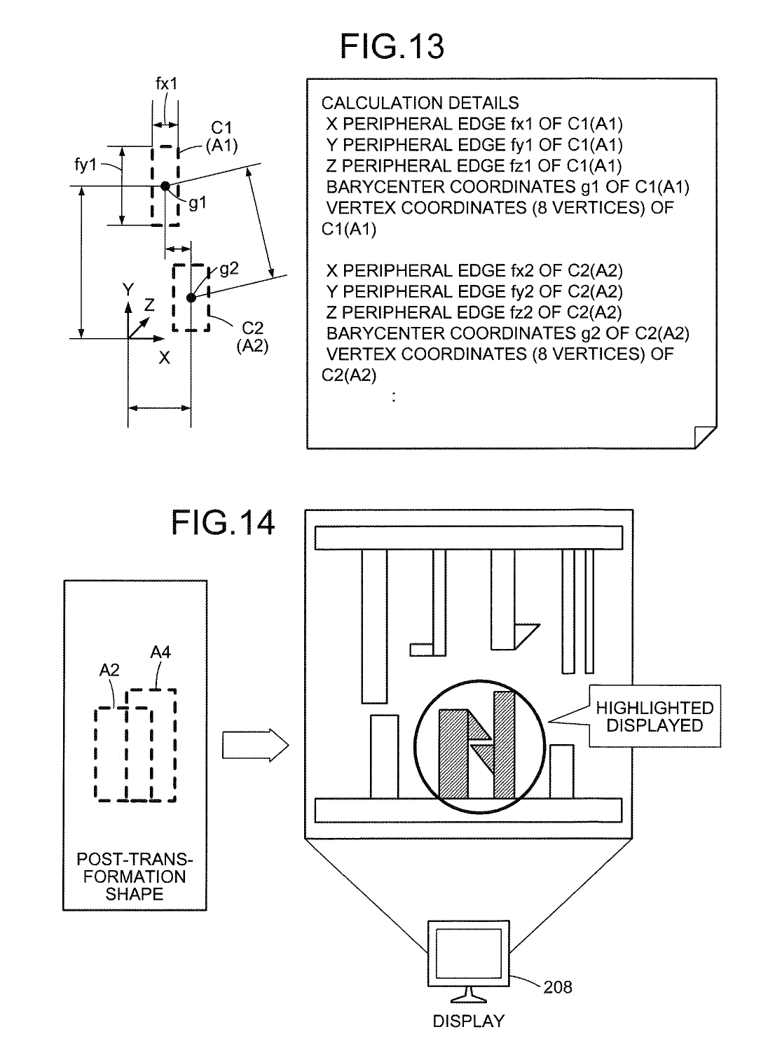

FIG. 13 is an explanatory diagram of an example of calculation of condition determination parameters. For example, the calculating unit 1007 derives information for each of the components C1 and C2, based on the vertices of the components C1 and C2. Each of the components C1 and C2 is a cuboid and thus, has 8 vertices. The calculating unit 1007 derives the X peripheral edges fx1 and fx2, Y peripheral edges fy1 and fy2, Z peripheral edges z1 and fz2, and barycenter coordinates g1 and g2 of each cuboid. The X peripheral edges fx1 and fx2 represent lengths in the X-axis direction. The Y peripheral edges fy1 and fy2 represent lengths in the Y-axis direction. The Z peripheral edges fz1 and fz2 represent lengths in the Z-axis direction.

The judging unit 1008 then judges whether information indicating the positional relation calculated by the calculating unit 1007 meets a condition set based on the design rule R. For example, the judging unit 1008 substitutes the information calculated by the calculating unit 1007 into the acquired conditional expression and thereby, judges whether the information meets the condition. In the example of FIG. 13, the judging unit 1008 substitutes the component C1 as the target shape A1 and component C2 as the target shape A2, in the conditional expression.

The output unit 1010 outputs the result of the judgment by the judging unit 1008. The output unit 1010 outputs the judgment results in the form of, for example, display on the display 208 or transmission to an external apparatus through the I/F 209. The judgment results may be stored to a memory device, such as the ROM 203 and the disk 205. Configuration may be such that the output unit 1010 outputs the judgment result if the judging unit 1008 judges that the information indicating the positional relation meets the condition.

FIG. 14 is an explanatory diagram of an example of highlighted display. The display making unit 1009 generates information for performing highlighted display of a combination that is judged by the judging unit 1008 to be a combination for which information indicating the positional relation meets a condition. Whether the highlighted display is to be performed may be determined by, for example, an instruction from the user received through the receiving unit 1001. The output unit 1010 displays the object obj indicated by the design information 300 on the display 208, based on the information made by the display making unit 1009.

Thus, the verifier performs verification of a portion displayed in a highlighted form on the display 208 based on the design rule R. This prevents a case where an omission in verification occurs consequent to the skill of the verifier.

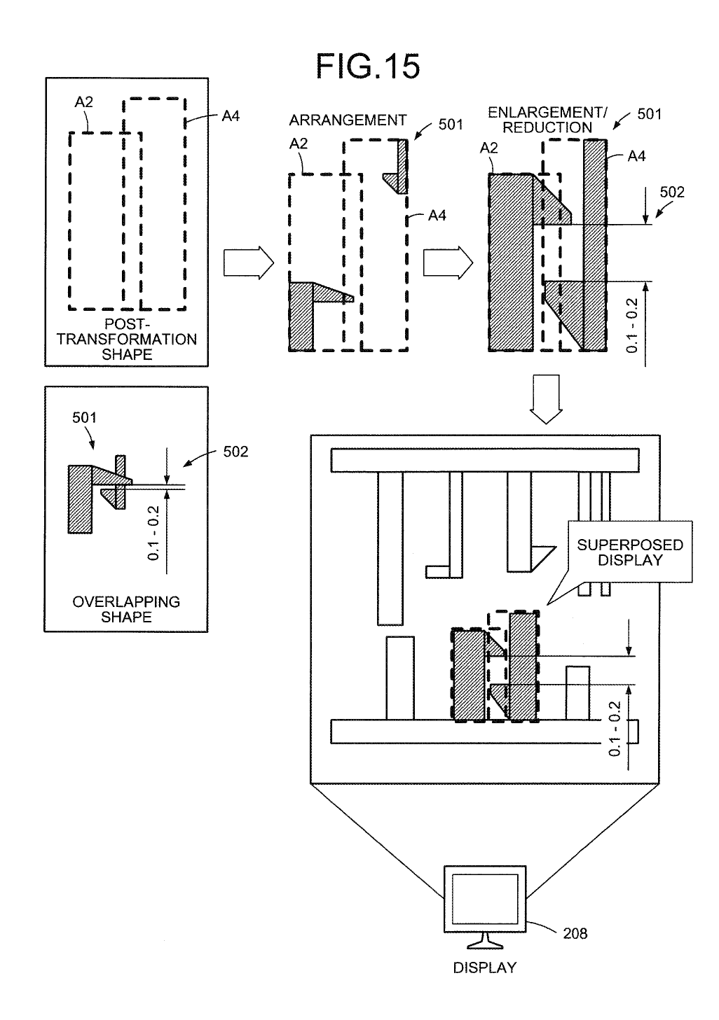

FIG. 15 is an explanatory diagram of an example of overlapping display. The display making unit 1009 changes the size of the overlapping shape 501 to the size of the combination of components that require verification and thereby, generates information superposed on the combination on the display. Whether the overlapping shape 501 is to be superposed may be determined by, for example, an instruction from the user received through the receiving unit 1001.

The display making unit 1009 generates information for displaying the display dimension 502 together with the combination of the components that require verification. Whether the display dimension 502 is to be displayed may be determined by, for example, an instruction from the user received through the receiving unit 1001.

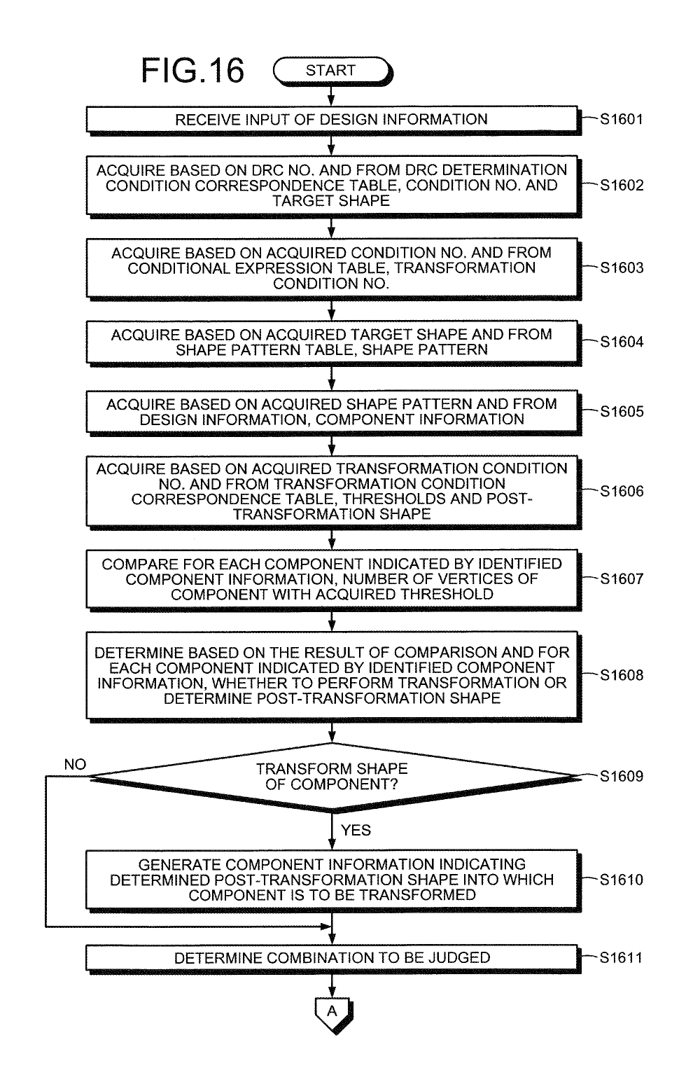

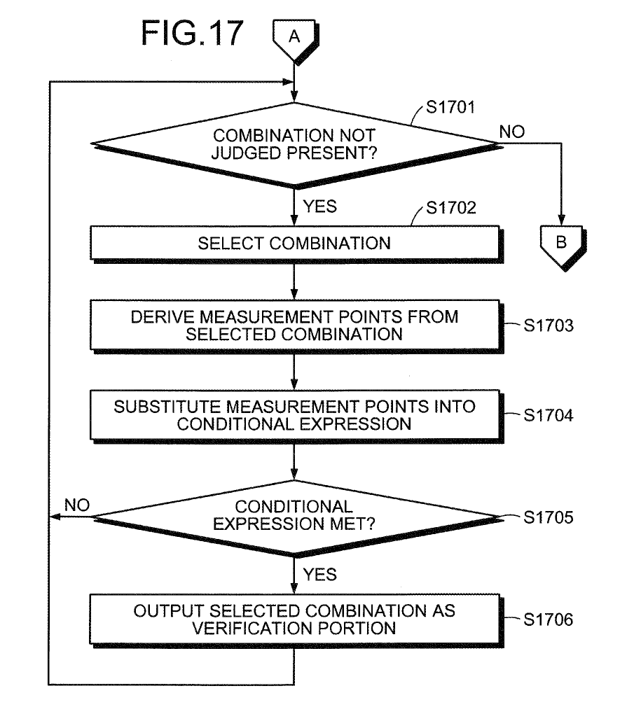

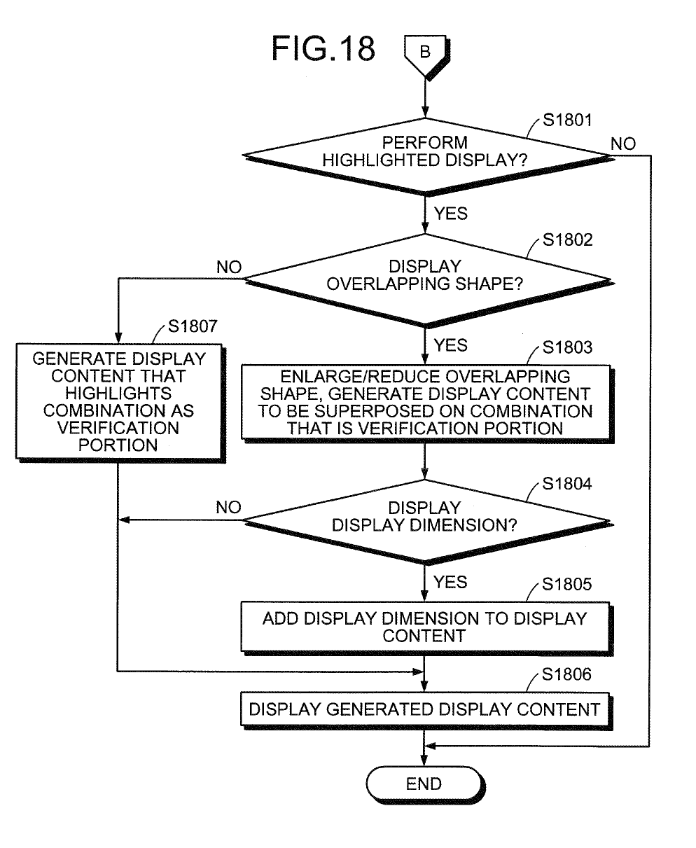

FIGS. 16, 17, and 18 are flowcharts of an example of a verification support procedure by the verification support apparatus. The verification support apparatus 100 receives input of the design information 300 (step S1601), and based on the DRC no. representing the design rule R, acquires from the DRC determination condition correspondence table 600, a condition no. corresponding to the design rule R and a target shape to which the design rule R applies (step S1602). In the above example, the DRC no. is “DRC0002”, so that the condition no. “C0002”, the target shape A1 “tab”, and the target shape A2 “tab” are acquired.

The verification support apparatus 100 acquires from the conditional expression table 700, a conditional expression and a transformation condition no. based on the acquired condition no. (step S1603), and based on the acquired target shape, acquires a shape pattern from the shape pattern table 800 (step S1604). In the above example, the record 701-1 is acquired from the conditional expression table 700 and thus, the transformation condition Nos. “M0003” and “M0004” are acquired.

The verification support apparatus 100, based on the acquired shape pattern, acquires component information from the design information 300 (step S1605), and based on the acquired transformation condition Nos., acquires thresholds and post-transformation shapes from the transformation condition correspondence table 900 (step S1606). In the above example, a cuboid is the post-transformation shape. For each component indicated by the identified component information, the verification support apparatus 100 compares the number of vertices of the component with the acquired threshold (step S1607), and for each component indicated by the identified component information, determines whether to perform transformation or determines a post-transformation shape, based on the result of the comparison (step S1608). In the above example, it is determined that the components B1 to B4 are to be transformed into cuboids.

The verification support apparatus 100 determines whether to transform the shape of a component (step S1609). Upon determining not to transform the shape of any of components (S1609: NO), the verification support apparatus 100 proceeds to step S1611. Upon determining to transform the shape of a component (S1609: YES), the verification support apparatus 100 generates component information indicating the determined post-transformation shape into which the component is to be transformed (step S1610), and determines a combination to be judged (step S1611). In the above example, the component information is generated as information indicating the components C1 to C4 into which the components B1 to B4 have been transformed, each of the components C1 to C4 representing the smallest cuboid among cuboids surrounding each of the components B1 to B4.

The verification support apparatus 100 determines whether a combination not judged is present (step S1701). If a combination not judged is present (step S1701: YES), the verification support apparatus 100 selects a combination (step S1702). In this manner, each combination is judged to determine if verification according to the design rule R is required. The verification support apparatus 100 derives measurement points from the selected combination (step S1703), and substitutes the measurement points into the conditional expression (step S1704). The measurement points include, for example, barycenters, peripheral edges, and vertices.

The verification support apparatus 100 determines whether the conditional expression is met (step S1705). If the conditional expression is met (step S1705: YES), the verification support apparatus 100 outputs the selected combination as a verification portion (step S1706), and returns to step S1701. A verification portion is the portion that requires verification. If the conditional expression is not met (step S1705: NO), the verification support apparatus 100 returns to step S1701.

If all combinations have been judged (step S1701: NO), the verification support apparatus 100 determines whether to perform highlighted display of the combination detected as the verification portion (step S1801). If performing highlighted display (step S1801: YES), the verification support apparatus 100 determines whether to display the overlapping shape 501 (step S1802). If displaying the overlapping shape 501 (step S1802: YES), the verification support apparatus 100 enlarges or reduces the overlapping shape 501 to generate display content to be superposed on the combination that is the verification portion (step S1803).

The verification support apparatus 100 determines whether to display the display dimension 502 (step S1804). If displaying the display dimension 502 (step S1804: YES), the verification support apparatus 100 adds the display dimension 502 to the display content (step S1805), and proceeds to step S1806. If not displaying the overlapping shape 501 (step S1802: NO), the verification support apparatus 100 generates display content that highlights the combination as the verification portion (step S1807), and proceeds to step S1806. If not displaying the display dimension 502 (step S1804: NO), the verification support apparatus 100 displays the generated display content, following step S1807 or S1805 (step S1806), and ends the series of operations. If not performing highlighted display (step S1801: NO), the verification support apparatus 100 ends the series of operations.

As described above, the verification support apparatus reduces the number of vertices of a component that has many vertices among a group of components corresponding to a shape to which a design rule concerning the positional relation between components applies, and calculates the positional relation. As a result, calculation of the positional relation between components is simplified, and portions that require verification can be narrowed down by a simple calculation.

In a conventional case, for example, the verifier visually searches for a similar shape defined in an item described in the design rule and checks the similar shape found. In another case, for example, the design rule and a portion that requires verification are correlated in advance with a shape to which the design rule applies, and a verification result and the verification portion are displayed when verification is performed. In still another case, a shape to which the design rule applies is registered in advance with the design rule, and a portion that requires verification is retrieved by a shape-based search of design information subject to verification. These cases take a long time to retrieve the portion that requires verification, and increase the possibility that an omission in verification occurs consequent to the skill of the verifier. Even if a shape-based search is performed, the retrieved portion is not always a portion that requires verification. For example, when the design rule is for verification of the degree by which “tab” shapes overlap, if two “tab” shapes retrieved by shape-based search are away from each other, verification is unnecessary.

According to the verification support apparatus of the embodiments, portions that require verification can be narrowed down. This prevents a case where an omission in verification occurs consequent to the skill of the verifier. According to the verification support apparatus, among combinations of components having shapes to which the design rule applies, a combination that requires verification and a combination that does not require verification are distinguished from each other. As a result, portions of an object that require verification can be narrowed down, and verification according to the design rule is performed efficiently.

The verification support apparatus compares the number of vertices of a component with a threshold corresponding to a shape and thereby, determines whether to perform transformation that reduces the number of vertices. For example, shape transformation is performed in a case where calculation of information indicating the positional relation between components is simplified by transforming the shape of a component having many vertices.

The verification support apparatus transforms at least one component among multiple components into the smallest sphere among spheres surrounding the component, or transforms at least one component among multiple components into the minimum cuboid among cuboids surrounding the one component. This simplifies calculation of information indicating the positional relation between components.

The verification support method described in the present embodiment may be implemented by executing a prepared program on a computer such as a personal computer and a workstation. The program is stored on a computer-readable recording medium such as a hard disk, a flexible disk, a CD-ROM, an MO, and a DVD, read out from the computer-readable medium, and executed by the computer. The program may be distributed through a network such as the Internet.

According to one aspect of the present embodiment, calculation of the positional relation between components can be simplified.

All examples and conditional language provided herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A computer-readable recording medium storing a verification support program causing a computer to execute a process comprising:
generating based on design information expressing an object, component information indicating components of the object, the components indicated correspond to a shape to which a design rule concerning positional relation applies and for at least one of the components, a number of vertices of the component is reduced;
calculating based on the generated component information, information indicating a positional relation between the components;
determining whether the calculated information indicating the positional relation meets a condition prescribed by the design rule; and
outputting a determination result.

2. The computer-readable recording medium according to claim 1, the process further comprising
determining for each of the components, whether to reduce the number of vertices of the component, based on a comparison between the number of vertices of the component and a threshold corresponding to the shape of the component, wherein
the generating of the component information includes generating the component information indicating the components for which a reduction of the number of vertices is determined.

3. The computer-readable recording medium according to claim 1, wherein
the generating of the component information includes generating the component information indicating the components, among which at least one component is transformed into a smallest cuboid among cuboids surrounding the component.

4. The computer-readable recording medium according to claim 1, wherein
the generating of the component information includes generating the component information indicating the components, among which at least one component is transformed into a smallest sphere among spheres surrounding the component.

5. The computer-readable recording medium according to claim 1, wherein
the outputting includes outputting the determination result to be displayed in a highlighted form, when the calculated information indicating the positional relation is determined to meet the condition.

6. A verification support method executed by a computer, the verification support method comprising:
generating based on design information expressing an object, component information indicating components of the object, the components indicated correspond to a shape to which a design rule concerning positional relation applies and for at least one of the components, a number of vertices of the component is reduced;
calculating based on the generated component information, information indicating a positional relation between the components;
determining whether the calculated information indicating the positional relation meets a condition prescribed by the design rule; and
outputting a determination result.

7. A verification support apparatus comprising
a processor configured to:
generate based on design information expressing an object, component information indicating components of the object, the components indicated correspond to a shape to which a design rule concerning positional relation applies and for at least one of the components, a number of vertices of the component is reduced;
calculate based on the generated component information, information indicating a positional relation between the components;
determine whether the calculated information indicating the positional relation meets a condition prescribed by the design rule; and
output a determination result.
